(19) United States
(12) Patent Application Publication
(10) Pub. No.: US 2025/0074736 A1
(43) Pub. Date: Mar. 6, 2025

(54) ELECTRODE STACKING APPARATUS

(71) Applicant: TOYOTA JIDOSHA KABUSHIKI KAISHA, Toyota-shi (JP)

(72) Inventor: Nobuhira ABE, Toyota-shi (JP)

(73) Assignee: TOYOTA JIDOSHA KABUSHIKI KAISHA, Toyota-shi (JP)

(21) Appl. No.: 18/787,279

(22) Filed: Jul. 29, 2024

(30) Foreign Application Priority Data
Aug. 29, 2023 (JP) 2023-139013

(51) Int. Cl. B65H 29/30; H02K 41/03

(52) U.S. Cl. CPC B65H 29/30; H02K 41/031; B65H 2555/13; B65H 2701/19

(57) ABSTRACT

An electrode stacking apparatus includes a stator with a horizontally installed main surface and multiple coils arranged under the main surface. A movable unit for stacking work includes a first mover that is movable above the main surface by magnetic levitation, an electrode holding unit, and a driving mechanism. The electrode holding unit is configured to press, from above, the base on top of the first mover and the sheet-type electrodes fed on the base's top surface. The driving mechanism drives the electrode holding unit by an external force acting thereon. The movable unit for operation work includes a second mover which can move above the main surface and an operation unit which operates the driving mechanism. A control unit is configured to control movements of the movable unit for stacking work and the movable unit for operation work by adjusting an amount of current flowed through the coils.

### CROSS REFERENCE TO RELATED APPLICATIONS

This application is based upon and claims the benefit of priority from Japanese patent application No. 2023-139013, filed on Aug. 29, 2023, the disclosure of which is incorporated herein in its entirety by reference.

### BACKGROUND

The present disclosure relates to an electrode stacking apparatus.

An apparatus for aligning and stacking sheet-type electrodes is known.

For example, in the electrode stacking apparatus described in Japanese Unexamined Patent Application Publication No. 2022-174961, a conveyance apparatus located above a planar motor apparatus having a plurality of movers that are movable above the surface of a flat stator by magnetic levitation is configured to stack new sheet-type electrodes on a stacked-electrode holder of the movers. In this case, the movers move synchronously with the movement of the sheet-type electrodes.

### SUMMARY

In the above-described apparatus, the orientation of the sheet-type electrodes held by the conveyance apparatus may be inclined with respect to the vertical axis. However, in this case, the above-described apparatus has a problem in suitably operating the clamp of the stacked-electrode holder.

The present disclosure has been made to solve such a problem and provides an electrode stacking apparatus for suitably stacking sheet-type electrodes.

An electrode stacking apparatus according to the present disclosure includes a stator, a movable unit for stacking work, a movable unit for operation work, and a control unit.

The stator includes a horizontally installed main surface and a plurality of coils arranged under the main surface.

The movable unit for stacking work includes a first mover, an electrode holding unit, and a driving mechanism.

The first mover is movable above the main surface by magnetic levitation.

The electrode holding unit is configured to press, from above, the base installed on an upper part of the first mover and a sheet-type electrode fed on a top surface of the base.

The driving mechanism drives the electrode holding unit by an external force acting thereon.

The movable unit for operation work includes a second mover that is movable above the main surface and an operation unit fixed to the second mover and configured to operate the driving mechanism by coming in contact with the driving mechanism.

The control unit is configured to control respective movements of the movable unit for stacking work and the movable unit for operation work by adjusting an amount of current to be flowed through the coils.

According to the present disclosure, an electrode stacking apparatus for suitably stacking sheet-type electrodes can be provided.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an overall perspective view of an electrode stacking apparatus 1 according to an embodiment;

FIG. 2 is a perspective view of a movable unit for stacking work and a movable unit for operation work;

FIG. 3 is a first side view showing movement in a movable unit for stacking work and a movable unit for operation work;

FIG. 4 is a second side view showing movements of a movable unit for stacking work and a movable unit for operation work;

FIG. 5 is a first top surface view showing movements of a movable unit for stacking work and a movable unit for operation work; and

FIG. 6 is a second top surface view showing movements of a movable unit for stacking work and a movable unit for operation work.

### DESCRIPTION OF EMBODIMENTS

Hereinafter, the present disclosure will be described through embodiments of the present disclosure, but the present disclosure is not limited to the following embodiments. Furthermore, not all of the configurations described in the embodiments are essential as means for solving the problems. For clarity of description, the following descriptions and drawings have been omitted and simplified as appropriate. In each drawing, the same elements have the same reference numerals, and duplicate descriptions have been omitted as necessary.

### Embodiments

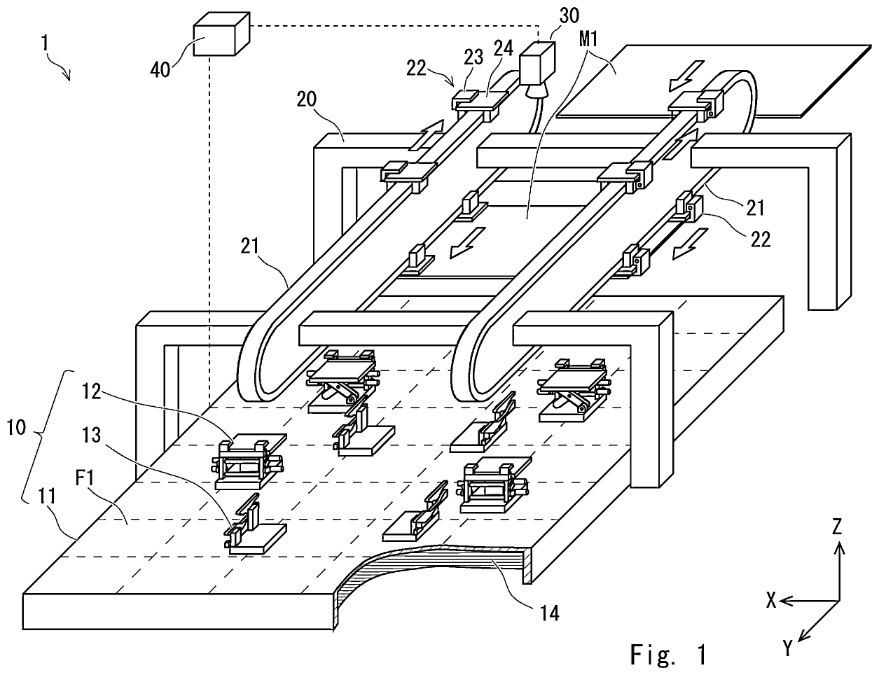

Hereinafter, embodiments of the present disclosure will be described with reference to the drawings. FIG. 1 is an overall perspective view of an electrode stacking apparatus 1 according to an embodiment. The electrode stacking apparatus 1 is an apparatus for stacking a plurality of sheet-type electrodes. The electrode stacking apparatus 1 manufactures an electrode stack by stacking a plurality of sheet-type electrodes. The electrode stack is used as a battery mounted on a vehicle, for example. The sheet-type electrode may be, for example, an electrode of a solid-state battery or an electrode of a semi-solid state battery. The thickness of the sheet-type electrode is, for example, about 200 micrometers to 1000 micrometers. In the following description, the sheet-type electrodes may be referred to simply as an electrode.

The electrode stacking apparatus 1 shown in FIG. 1 includes a planar motor 10, a conveyance apparatus 20, a camera 30, and a control unit 40 as main components thereof. In the electrode stacking apparatus 1, the conveyance apparatus 20 receives a rectangular electrode M1 and sequentially provides the received electrode M1 to the planar motor 10. Thus, the planar motor 10 stacks the electrode M1.

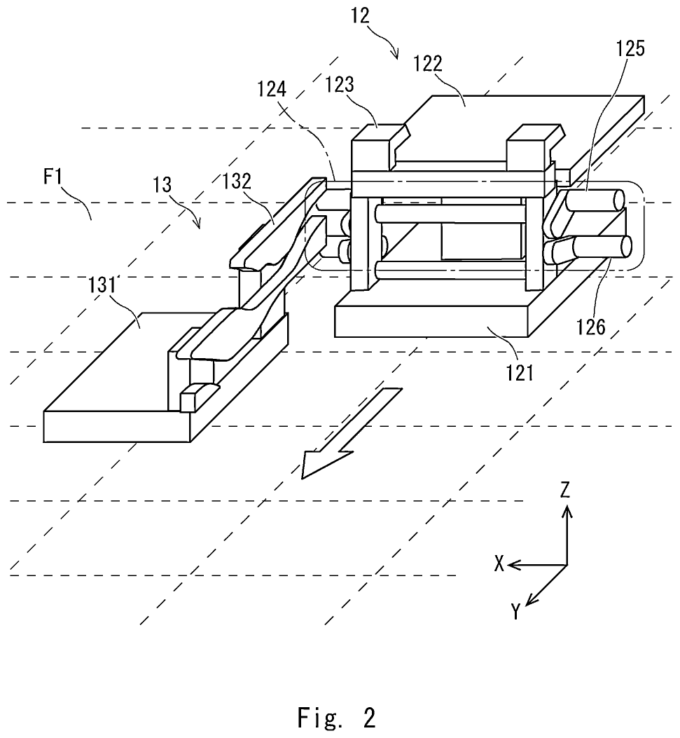

For the sake of convenience of explanation of the positional relationship of the structural components, a right-handed orthogonal coordinate system is shown in FIG. 1. In FIG. 2 and the subsequent drawings, when an orthogonal coordinate system is shown, the X-axis, Y-axis, and Z-axis directions in the orthogonal coordinate systems shown in these drawings coincide with the X-axis, Y-axis, and Z-axis directions of the orthogonal coordinate system shown in FIG. 1.

In the planar motor 10, a mover provided on a stator having a flat surface moves about on the flat surface of the stator. The planar motor 10 includes a stator 11, a movable unit for stacking work 12, and a movable unit for operation work 13 as main components thereof.

The stator 11 has a horizontally installed main surface F1 and a plurality of coils 14 arranged under the main surface F1. The stator 11 generates a magnetic field in the main surface F1 by causing a current to flow through the coils 14. Thus, the planar motor 10 levitates the movable unit for stacking work 12 and the movable unit for operation work 13 that are installed on the main surface F1 and causes the levitated movable unit for stacking work 12 and the levitated movable unit for operation work 13 to move. The stator 11 may also have a plurality of magnetic sensors along the main surface F1. The magnetic sensors are used to detect positions of the movable unit for stacking work 12 and the movable unit for operation work 13, which move above the main surface F1 by magnetic levitation.

The stator 11 provides the output of the magnetic sensors to the control unit 40. Thus, the control unit 40 recognizes the optimal positions of the movable unit for stacking work 12 and the movable unit for operation work 13. The amount of current to be flowed through the coils 14 of the stator 11 is adjusted by the control unit 40. Thus, the control unit 40 suitably controls the movement of the movable unit for stacking work 12 and the movement of the movable unit for operation work 13. Details of the movable unit for stacking work 12 and the movable unit for operation work 13 will be described later.

The conveyance apparatus 20 is installed above the planar motor 10 and provides the electrode M1 to the movable unit for stacking work 12 of the planar motor 10. The conveyance apparatus 20 includes a rail 21 and a conveyance unit 22 as main components thereof.

The rail 21 has a loop configuration and guides the conveyance unit 22 engaged therewith. The rail 21 has a linear part parallel to the main surface F1, the linear part opposing the main surface F1. The conveyance unit 22 is engaged with the linear part of the rail 21 in a linearly movable manner. The conveyance apparatus 20 shown in FIG. 1 defines an ellipse shape including the linear part. The rail 21 is arranged such that the surface having an ellipse shape defined by the rail 21 is perpendicular to the main surface F1 and parallel to the conveyance direction of the electrode M1. Further, the conveyance apparatus 20 has two rails 21 arranged side-by-side in parallel to the conveyance direction (Y-axis direction) of the electrode M1. In the aforementioned case, the distance between the two rails 21 corresponds to the size of the electrode M1. Therefore, the conveyance apparatus 20 can hold the edge part of the electrode M1.

The conveyance unit 22 receives and holds the electrode M1. The conveyance unit 22 conveys the electrode M1 it is holding along the rail 21. The conveyance unit 22 provides, to the movable unit for operation work 13, the electrode M1 to be conveyed. The conveyance unit 22 includes a suspension clamp 23 and a suspension base 24 as main components thereof. The suspension clamp 23 can sandwich the electrode M1 between it and the suspension base 24. The suspension clamp 23 is set so as to be switchable between a state in which the electrode M1 is sandwiched and held between it and the suspension base 24 and a state in which the electrode M1 is received or the electrode M1 is released by any given mechanism (not shown). The suspension base 24 is engaged with the rail 21 and moves linearly along the rail 21.

The conveyance apparatus 20 may have a plurality of the conveyance units 22. With such a configuration, the conveyance apparatus 20 is capable of handling electrode M1 of various sizes, for example. Further, by moving a plurality of the conveyance units 22 in the conveyance direction, the conveyance apparatus 20 can have the conveyance units 22 move along the rail 21 formed in a loop to thereby continuously convey a plurality of electrodes M1. The conveyance apparatus 20 may, for example, convey a plurality of electrodes M1 by providing an electrode M1 received on the upstream side to the movable unit for operation work 13 on the downstream side and repeating a movement (i.e., making a reciprocating motion) for causing the conveyance unit 22 to move to the upstream side.

The rail 21 may guide an autonomous conveyance unit 22. In this case, the conveyance unit 22 may have a motor for autonomous traveling. The rail 21 may also include a movable unit such as a conveyor belt for driving the conveyance unit 22. In this case, the conveyance unit 22 may follow the rail 21.

The camera 30 is installed above the conveyance apparatus 20 and is set up to take a picture in the downward direction from the installation position. The camera 30 takes a picture of the electrode M1 conveyed by the conveyance apparatus 20 to generate image data of the external form of the electrode M1 and provides the generated image data to the control unit 40. Therefore, the image data generated by the camera 30 and provided to the control unit 40 includes information about the position and the inclination of the electrode M1 conveyed by the conveyance apparatus 20 with reference to the external form thereof. The control unit 40 receives the aforementioned image data and performs control of the movable unit for stacking work 12 and the movable unit for operation work 13 so that the position and the inclination of the electrode M1 match those in the received image data. The camera 30 may take a picture of the marker on the electrode M1 instead of taking a picture of the electrode M1 capturing the external form thereof.

The control unit 40 has a control substrate including a computing device such as a CPU (Central Processing Unit) or an MPU (Micro Processing Unit), and a storage device storing at least a program for the electrode stacking apparatus 1 to perform the functions of the present disclosure. The control unit 40 at least controls the movement of the movable unit for stacking work 12 and the movable unit for operation work 13 of the planar motor 10. That is, the control unit 40 controls the respective movements of the movable unit for stacking work 12 and the movable unit for operation work 13 by adjusting the amount of current to be flowed through the coils of the stator 11. The control unit 40 receives image data from the camera 30, and uses the received image data to perform control so that the position and the inclination of the movable unit for stacking work 12 and the position and the inclination of the movable unit for operation work 13 correspond to the position and the inclination of the electrode M1.

The control unit 40 may control the movement of the conveyance apparatus 20. When the control unit 40 performs control of the movement of the conveyance apparatus 20, the control unit 40 may perform control so that the movement of the conveyance unit 22 of the conveyance apparatus 20 synchronizes with the movement of the movable unit for stacking work 12 of the planar motor 10. The control unit 40 may also perform control of the camera 30. In this case, the control unit 40 may, for example, perform control movements of the camera 30 for pan, tilt, and zoom.

Next, the movable unit for stacking work 12 and the movable unit for operation work 13 will be described in more detail with reference to FIG. 2. FIG. 2 is a perspective view of the movable unit for stacking work 12 and the movable unit for operation work 13. The movable unit for stacking work 12 receives and stacks the electrode M1 provided by the conveyance apparatus 20. At this time, the movable unit for stacking work 12 moves in the direction indicated by the arrow in FIG. 2, which is conveyance direction of the conveyance apparatus 20. The movable unit for operation work 13 is stopped at a position which is a position at which it comes in contact with the movable unit for stacking work 12 in an operable manner. The movable unit for stacking work 12 comes in contact with the movable unit for operation work 13 while moving in the conveyance direction. As a result, the movable unit for operation work 13 brought into a state of receiving the electrode M1 and further brought into a state of holding the received electrode M1.

The movable unit for stacking work 12 includes a first mover 121, a base 122, an electrode holding unit 123 and a driving mechanism 124 as main components thereof.

The first mover 121 is levitated above the stator 11 by magnetic levitation whereby it can move above the main surface F1. In order to realize the aforementioned function, the first mover 121 includes a magnet. The magnet is preferably a permanent magnet such as a neodymium magnet. The first mover 121 supports the base 122, the electrode holding unit 123 and the driving mechanism 124 on an upper part thereof.

The base 122 is a flat plate member including a main surface for receiving the electrode M1. The base 122 is configured to be vertically movable so that the electrode M1 can be stacked thereon. The base 122 may be supported by an elastic body such as a spring so that it is vertically movable. The base 122 may be supported by a motor so that it is vertically movable. By this configuration, the base 122 can be lowered according to the number of electrodes M1 to be stacked.

The electrode holding unit 123 presses, from above, the base 122 installed on the upper part of the first mover 121 and the electrode M1 fed on the top surface of the base 122. The electrode holding unit 123 is configured to perform a prescribed action by the driving mechanism 124. Details of a prescribed action will be described later.

The driving mechanism 124 drives the electrode holding unit 123 by an external force acting thereon. The driving mechanism 124 has a first lever 125 and a second lever 126. The first lever 125 and the second lever 126 come in contact with an operation unit 132 of the movable unit for operation work 13, whereby they are operated to thereby drive the electrode holding unit 123.

The movable unit for operation work 13 includes a second mover 131 and the operation unit 132 as main components thereof. The second mover 131 can move above the main surface F1. The second mover 131, like the first mover 121, includes a magnet for moving above the main surface F1 in a levitated manner. The second mover 131 supports the operation unit 132.

The operation unit 132 is fixed to the second mover 131 and comes in contact with the driving mechanism 124, whereby the driving mechanism 124 is operated. The operation unit 132 according to the present disclosure includes a cam that engages with the first lever 125 and the second lever 126. Therefore, due to the change in the relative position between the movable unit for stacking work 12 and the movable unit for operation work 13, the operation unit 132 of the movable unit for operation work 13 operates the first lever 125 and the second lever 126 that come in contact therewith, whereby the electrode holding unit 123 is driven.

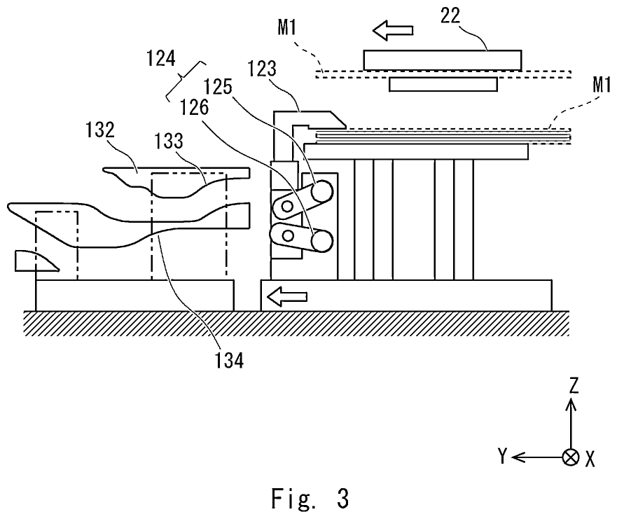

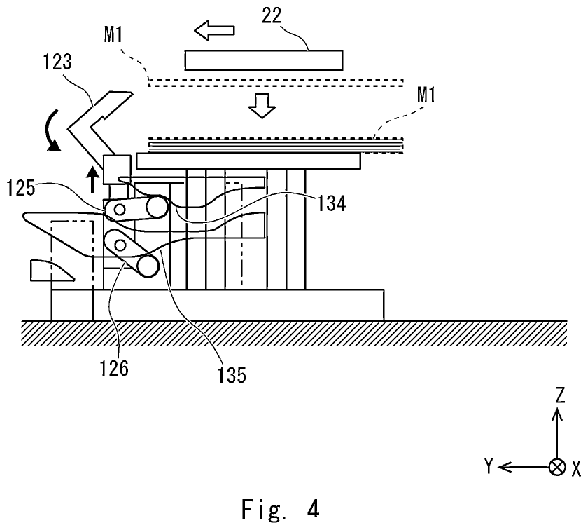

Next, an example of the movements of the electrode holding unit 123 and the driving mechanism 124 will be described with reference to FIGS. 3 and 4. FIG. 3 is a first side view showing movements of the movable unit for stacking work 12 and the movable unit for operation work 13.

In FIG. 3, the conveyance unit 22 of the conveyance apparatus 20 carries the electrode M1 in the conveyance direction. The movable unit for stacking work 12, which is located downstream of the conveyance unit 22, is moved in the conveyance direction with respect to the conveyance unit 22. On the other hand, the movable unit for operation work 13 is stopped on the downstream side with respect to the conveyance direction. The movable unit for stacking work 12 is in a state just before it comes in contact with the movable unit for operation work 13. At this time, the electrode holding unit 123 is in a holding state for holding from above the plurality of electrodes M1 that has been already received.

The first lever 125 of the driving mechanism 124 has a driven element at a position where is comes in contact with the first cam 133 of the operation unit 132. The driven element is driven by coming in contact with the first cam 133 and following it. When the driven element of the first lever 125 is operated by the first cam 133, the first lever 125 drives the electrode holding unit 123. The second lever 126 of the driving mechanism 124 has a driven element that comes in contact with the second cam 134 of the operation unit 132. The electrode holding unit 123 is configured such that it switches between a holding state in which the electrode M1 is pressed from above and an open state in which a new electrode M1 can be received from above depending on the movement of the driven element.

FIG. 4 is a second side view showing a movement of the movable unit for stacking work 12 and the movable unit for operation work 13. The movable unit for operation work 13 shown in FIG. 4 is in a state in which it is in contact with the movable unit for stacking work 12 due to it moving in the conveyance direction from being in the state shown in FIG. 3. The first lever 125 is operated by the first cam 133 to drive the electrode holding unit 123 in the open state. The second lever 126 is operated by the second cam 134 to drive the electrode holding unit 123 in the upward lifted state. As a result, the movable unit for stacking work 12 can receive the new electrode M1 from the conveyance unit 22.

The conveyance unit 22 releases the electrode M1 it has been holding and drops it down. After receiving the new electrode M1, the movable unit for stacking work 12 moves further in the conveyance direction. Then, the first lever 125 and the second lever 126 are operated by the operation unit 132, and the electrode holding unit 123 is switched from the open state to the holding state.

As described above, in the electrode stacking apparatus 1 of the present disclosure, the operation unit 132 of the movable unit for operation work 13 has a cam that come in contact with the driving mechanism 124, and the driving mechanism 124 of the movable unit for stacking work 12 has a driven element that is driven by coming in contact with the cam. Further, the electrode holding unit 123 is configured such that the state thereof is switched between a holding state in which the electrode M1 is pressed from above and an open state in which a new electrode M1 can be received from above depending on the movement of the driven element. Thus, the electrode stacking apparatus 1 can switch between the holding state and the open state by changing the relative positions thereof while bringing the movable unit for stacking work 12 and the movable unit for operation work 13 into contact with each other.

As described above, the electrode stacking apparatus 1 further includes the conveyance apparatus 20. The conveyance apparatus 20 is configured to at least hold and convey the electrode M1 along a conveyance path set above the stator 11, and to provide the electrode M1 to the movable unit for stacking work 12 that moves along the conveyance path. Thus, it is possible for the electrode stacking apparatus 1 to efficiently achieve stacking of the electrodes M1.

In the electrode stacking apparatus 1 of the present disclosure, the control unit 40 moves the movable unit for stacking work 12 along the conveying path in correspondence with the conveyance apparatus 20 conveying the electrode M1. In the electrode stacking apparatus 1, the control unit 40 performs control of the position of the movable unit for operation work 13 so that the electrode holding unit 123 is brought into a state of being opened when the conveyance apparatus 20 drops the electrode M1. Thus, the electrode stacking apparatus 1 can efficiently stack the electrode M1.

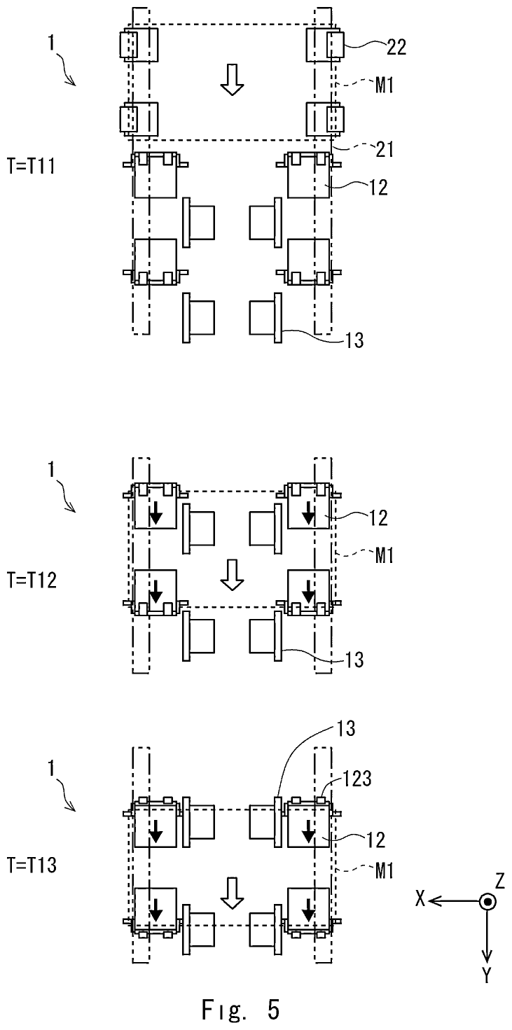

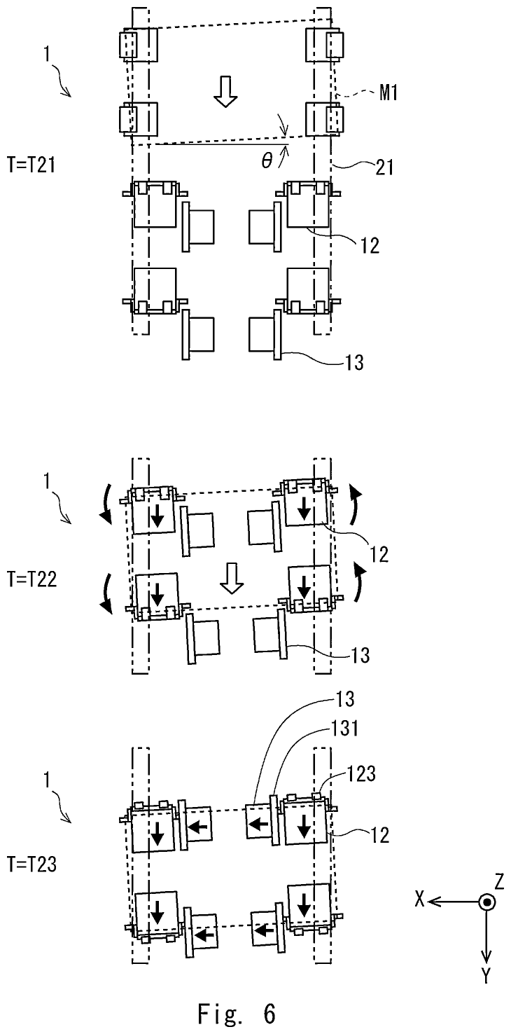

Next, the movements of the movable unit for stacking work 12 and the movable unit for operation work 13 will be described in more detail with reference to FIGS. 5 and 6. FIG. 5 is a first top surface view showing movements of the movable unit for stacking work 12 and the movable unit for operation work 13. FIG. 5 shows changes in the position of the movable unit for stacking work 12 and the position of the movable unit for operation work 13 over time T.

The electrode stacking apparatus 1 illustrated in the top drawing of the FIG. 5 shows the positions of the conveyance unit 22, the movable unit for stacking work 12, and the movable unit for operation work 13 at time T=T11. At time T=T11, the four conveyance units 22 is holding the edge part of an electrode M1 and moving in the conveyance direction. The four movable units for stacking work 12 are in a standby state along the conveyance direction defined by the two rails 21. The four movable units for operation work 13 are also in a standby state on the scheduled route of movement of each movable unit for stacking work 12.

The electrode stacking apparatus 1 illustrated in the middle drawing of FIG. 5 shows movement of the movable unit for stacking work 12 and movement of the movable unit for operation work 13 at time T=T12 after time T=T11. For the ease of understanding, the conveyance unit 22 conveying an electrode M1 is omitted in FIG. 5. At time T=T12, the movable unit for stacking work 12 is moved in the conveyance direction in accordance with the movement of the electrode M1. The movable unit for stacking work 12 located at a position just before it coming in contact with the movable unit for operation work 13. The movable unit for operation work 13 is on standby in the scheduled path of movement of each movable unit for stacking work 12.

The electrode stacking apparatus 1 illustrated in the bottom drawing of FIG. 5 shows movement of the movable unit for stacking work 12 and movement of the movable unit for operation work 13 at time T=T13 after time T=T12. Here, the movable unit for stacking work 12 comes in contact with the movable unit for operation work 13 whereby the electrode holding unit 123 is brought into a state of being opened. Accordingly, after the time T=T13, the movable unit for stacking work 12 receives a new electrode M1 from the conveyance apparatus 20.

Next, FIG. 6 will be described. FIG. 6 is a second top surface view showing movements of the movable unit for stacking work 12 and the movable unit for operation work 13. FIG. 6 shows movement of the electrode stacking apparatus 1 in a state where an electrode M1 is inclined with respect to a vertical axis (about the Z-axis). FIG. 6 shows changes in the position of the movable unit for stacking work 12 and the position of the movable unit for operation work 13 over time T.

The electrode stacking apparatus 1 shown in the top drawing of FIG. 6 shows the positions of the conveyance unit 22, the movable unit for stacking work 12, and the movable unit for operation work 13 at time T=T21. At time T=T21, the four conveyance units 22 are holding the edge part of an electrode M1 and moving in the conveyance direction. However, the electrode M1 shown in FIG. 6 is inclined at an angle θ with respect to a vertical axis.

The electrode stacking apparatus 1 shown in the middle row of FIG. 6 shows movement of the movable unit for stacking work 12 and movement of the movable unit for operation work 13 at time T=T22 after time T=T21. At time T=T22, the movable unit for stacking work 12 moves in the conveyance direction to match the movement of the electrode M1. At this time, the movable unit for stacking work 12 has a posture that is inclined at an angle θ with respect to the vertical axis in view of the inclination of the electrode M1. In addition, position of each of the four movable units for stacking work 12 is also adjusted in accordance with the position of the electrode M1 defined by its external form. The movable unit for stacking work 12 is located at a position just before it coming in contact with the movable unit for operation work 13. The movable unit for operation work 13 is on standby in the scheduled path of movement of each movable unit for stacking work 12. However, the movable unit for operation work 13 is inclined at an angle θ around the vertical axis in view of the posture of the movable unit for stacking work 12.

The electrode stacking apparatus 1 illustrated in the bottom drawing of FIG. 5 shows movement of the movable unit for stacking work 12 and movement of the movable unit for operation work 13 after time T=T22 at time T=T23. The movable unit for stacking work 12 comes in contact with the movable unit for operation work 13, whereby the electrode holding unit 123 is brought into a state of being opened.

From time T=T22 to time T=T23, the four movable units for stacking work 12 move in the conveyance direction while maintaining an inclination of angle θ, which is in correspondence with the inclination of the electrode M1. At this time, the movable unit for operation work 13 moves in a direction perpendicular to the conveyance direction corresponding to the position of the movable unit for stacking work 12. In the example of FIG. 6, the movable unit for operation work 13 moves in X-axis plus direction so as to maintain contact state between driven element of the driving mechanism 124 and the operation unit 132 in response to movement of the movable unit for stacking work 12 which moves in Y-axis plus direction while having inclination of angle θ around vertical axis.

When the movable unit for stacking work 12 and the movable unit for operation work 13 perform the above-mentioned movement, the electrode stacking apparatus 1 can suitably stack a new electrode M1 even when the electrode M1 is inclined. That is, the control unit 40 calculates position and inclination of electrode M1 from image data, and controls position and inclination of movable unit for stacking work 12 and the movable unit for operation work 13 according to the calculation result.

As described above, in the electrode stacking apparatus 1, the control unit 40 sets the inclination of the movable unit for stacking work 12 in view of the inclination of the electrode M1 with respect to the vertical axis based on the image data in which an image of the posture of the electrode M1 is captured from above the stator 11. Further, the control unit 40 performs control of the displacement of the movable unit for operation work 13 in the direction perpendicular to the conveyance path of the movable unit for operation work 13 in view of the position and the inclination of the movable unit for stacking work 12.

With the above configuration, the electrode stacking apparatus 1 can reduce the wasted area of the electrodes to be stacked. That is, the electrode stacking apparatus 1 efficiently stacks the sheet-type electrodes by suppressing misalignment of the newly stacked electrode M1. In addition, according to the above-described configuration, the electrode stacking apparatus 1 realizes conveyance and stacking of the sheet-type electrodes in a smaller area than when the sheet-type electrodes are conveyed using a conventional pallet. Furthermore, according to the above-described configuration, the electrode stacking apparatus 1 can flexibly cope with the stacking process by changing position settings of the conveyance unit 22 and the movable unit for stacking work 12 even when the sheet-type electrode of different size is used.

In the electrode stacking apparatus 1 according to the present embodiment, a plurality of sheet-type electrodes can be suitably stacked continuously by sequentially providing the sheet-type electrodes to the conveyance apparatus 20. That is, according to the present embodiment, an electrode stacking apparatus for suitably stacking the sheet-type electrodes can be provided.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The present disclosure is not limited by the foregoing. Various changes in the structure and details of the present disclosure can be made within the scope of the present disclosure that can be understood by a person skilled in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electrode stacking apparatus, comprising:
a stator including a horizontally installed main surface and a plurality of coils arranged under the main surface;
a movable unit for stacking work including:
a first mover that is movable above the main surface by magnetic levitation;
a base installed on an upper part of the first mover;
an electrode holding unit configured to press, from above, the base and a sheet-type electrode fed on a top surface of the base; and
a driving mechanism for driving the electrode holding unit by an external force acting thereon;
a movable unit for operation work including a second mover that is movable above the main surface and an operation unit fixed to the second mover and configured to operate the driving mechanism by coming in contact with the driving mechanism; and
a control unit configured to control respective movements of the movable unit for stacking work and the movable unit for operation work by adjusting an amount of current to be flowed through the coils.

2. The electrode stacking apparatus according to claim 1, wherein
the operation unit of the movable unit for operation work includes a cam that comes in contact with the driving mechanism,
the driving mechanism of the movable unit for stacking work includes a driven element that is driven by coming in contact with the cam, and
the electrode holding unit is configured such that a state thereof is switched between a holding state in which the electrode is pressed from above and an open state in which a new electrode can be received from above depending on the movement of the driven element.

3. The electrode stacking apparatus according to claim 1, further comprising a conveyance apparatus configured to at least hold and convey the electrode along a conveyance path set above the stator and provide the electrode to the movable unit for stacking work that moves along the conveyance path.

4. The electrode stacking apparatus according to claim 3, wherein the control unit is configured to move the movable unit for stacking work along the conveying path in correspondence with the conveying of the electrode by the conveyance apparatus and perform control of a position of the movable unit for operation work so that the electrode holding unit is brought into a state of being opened when the conveyance apparatus drops the electrode.

5. The electrode stacking apparatus according to claim 4, wherein the control unit is configured to set an inclination of the movable unit for stacking work in view of the inclination of the electrode with respect to the vertical axis based on the image data in which a posture of the electrode is captured from above the stator and to perform control of the displacement of the movable unit for operation work in the direction perpendicular to the conveyance path of the movable unit for stacking work in view of the position and the inclination of the movable unit for stacking work.
